(19) United States
(12) Patent Application Publication
(10) Pub. No.: US 2010/0081542 A1
(43) Pub. Date: Apr. 1, 2010

(54) Transmission mechanism capable of simultaneously measuring and controlling the transmission travel

(76) Inventor: Chen-Hui Ko, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,196

(22) Filed: Sep. 30, 2008

(51) Int. Cl. H02P 3/04

(52) U.S. Cl. 477/29

(57) ABSTRACT

A transmission mechanism capable of simultaneously measuring and controlling the transmission travel includes: a) a transmission unit having a reduction gearset and a transmission gear both of which are disposed within a housing; b) a motor installed at the external side of the housing for supplying power to the transmission unit; c) a transmission rod passing through the housing so as to engage with the transmission gear; d) a fixing sleeve disposed at the external side of the housing und mounted at one end of the transmission rod; and e) a sensing element opposing to the transmission gear and disposed within the housing for measuring the number of the rotation of the transmission gear. The sensing element is a magnetic reed pipe, and at least a magnet is disposed at the transmission gear. In this way, a transmission mechanism capable of simultaneously measuring and controlling the transmission travel ensures an accurate control of the transmission travel.

### BACKGROUND OF THE INVENTION

1. Field of the Invention

The invention relates to a transmission mechanism capable of simultaneously measuring and controlling the transmission travel, and more particularly, to a transmission mechanism having a magnetic reed pipe acting as a sensing element. Moreover, a transmission gear includes a magnet corresponding to the magnetic reed pipe for simultaneously measuring and controlling the change of the transmission travel of a transmission rod engaged with the transmission gear.

2. Description of the Related Art

As shown in FIG. 1, a treadmill includes a transmission mechanism 10 for adjusting the elevation angle of the platform 20 relative to the base frame 30. In this way, a practical adjustment of the angle of inclination of the platform 20 is achieved for meeting different requirements in respect of the angle of inclination of the platform 20. In order to control the angle of inclination of the platform 20, an element for sensing the angle of inclination is installed at a certain position of the treadmill. In this way, the change of the transmission travel of the transmission mechanism 10 is measured and controlled for adjusting the angle of inclination of the platform 20. However, this conventional transmission mechanism 10 requires a sensing element disposed at the external side thereof for providing the measuring signal of the change of the transmission travel. Then, the transmission state is controlled according to the measuring signal.

### SUMMARY OF THE INVENTION

An object of the invention is to provide a transmission mechanism capable of simultaneously measuring and controlling the transmission travel that ensures an accurate control of the transmission travel.

In order to achieve the above-mentioned object, the invention includes:

a) a transmission unit having a reduction gearset and a transmission gear both of which are disposed within a housing;

b) a motor installed at the external side of the housing for supplying power to the transmission unit;

c) a transmission rod passing through the housing so as to engage with the transmission gear;

d) a fixing sleeve disposed at the external side of the housing und mounted at one end of the transmission rod; and

e) a sensing element opposing to the transmission gear and disposed within the housing for measuring the number of the rotation of the transmission gear.

The sensing element is a magnetic reed pipe, and at least a magnet is disposed at the transmission gear.

Moreover, a magnetic reed pipe is uprightly disposed within a protection sleeve that is filled with a transparent fixing glue.

Furthermore, the axial direction of the magnetic reed pipe is preferably the same to the radial direction of the transmission gear. The transmission rod is a threaded rod.

### BRIEF DESCRIPTION OF THE DRAWINGS

The accomplishment of this and other objects of the invention will become apparent from the following descriptions and its accompanying figures of which:

FIG. 1 is a perspective view of a conventional transmission mechanism for adjusting the angle of inclination of the platform of a treadmill;

FIG. 2 is a perspective view of the structure of the invention;

FIG. 3 is a sectional view taken along the line 3-3 in FIG. 2;

FIG. 4 is a sectional view taken along the line 4-4 in FIG. 3;

FIG. 5 is a sectional view taken along the line 5-5 in FIG. 4;

FIG. 6 is a perspective view of a sensing element in form of a magnetic reed pipe disposed within a protection sleeve that is fitted with fixing glue; and

FIG. 7 is a sectional view taken along the line 7-7 in FIG. 6.

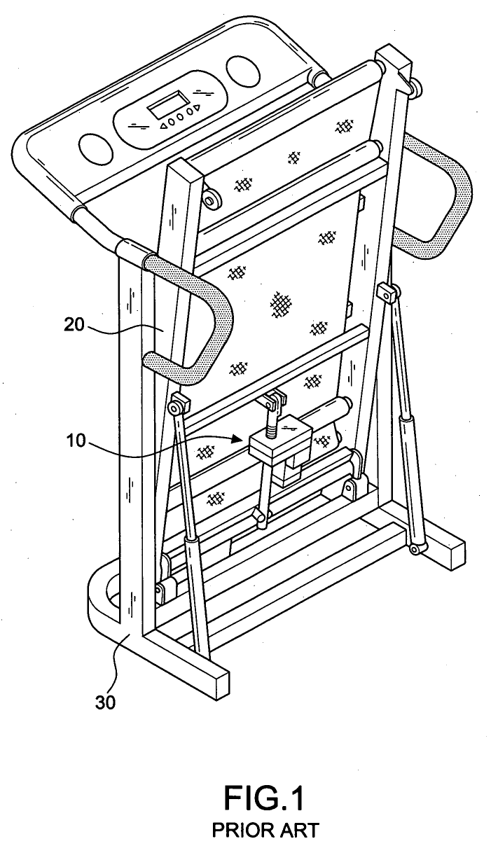

### DETAILED DESCRIPTION OF THE PREFERRED EMBODIMENT

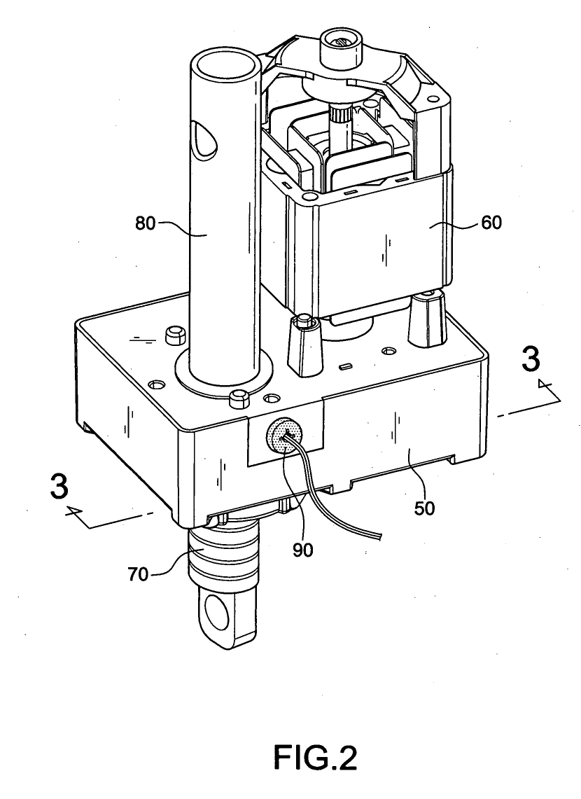

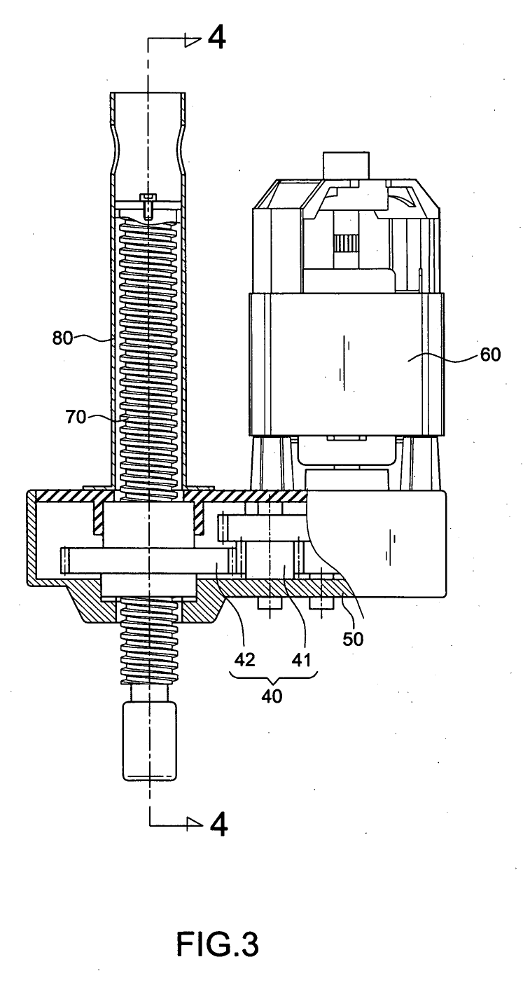

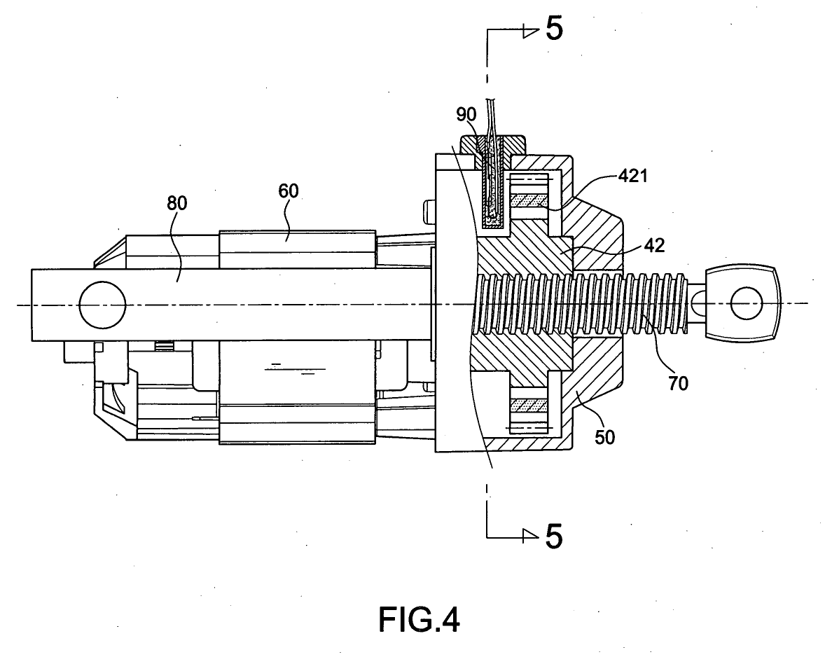

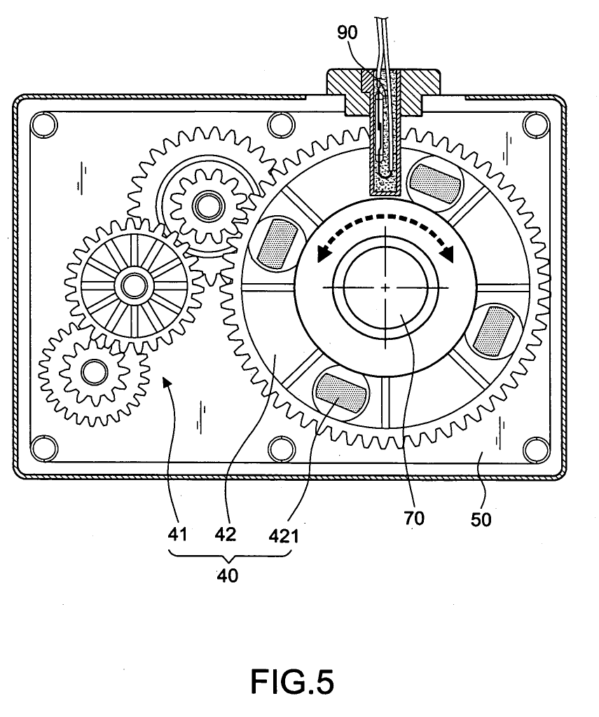

First of all, referring to FIGS. 2 through 5, a transmission mechanism capable of simultaneously measuring and controlling the transmission travel in accordance with the invention includes a transmission unit 40, a motor 60, a transmission rod 70, a fixing sleeve 80, and a sensing element 90.

The transmission unit 40 includes a reduction gearset 41 and a transmission gear 42 both of which are disposed within a housing 50.

The motor 60 is installed at the external side of the housing 50 for supplying power to the transmission unit 40.

The transmission rod 70 passes through the housing 50 so as to engage with the transmission gear 42. According to this embodiment, the transmission rod 70 is a threaded rod. In other words, the transmission gear 42 is driven via the reduction gearset 41by the motor 60 in rotation. Thereafter, the transmission rod 70 is driven by the thread within the transmission gear 42 for an axial displacement. This belongs to a conventional mechanic transmission so that no further descriptions are given hereinafter.

The fixing sleeve 80 is disposed at the external side of the housing 50 und mounted at one end of the transmission rod 70.

The sensing element 90 opposing to the transmission gear 42 is disposed within the housing 50 for measuring the number of the rotation of the transmission gear 42. According to this embodiment, the sensing element 90 is a magnetic reed pipe. Moreover, a magnet 421 is disposed at the transmission gear 42.

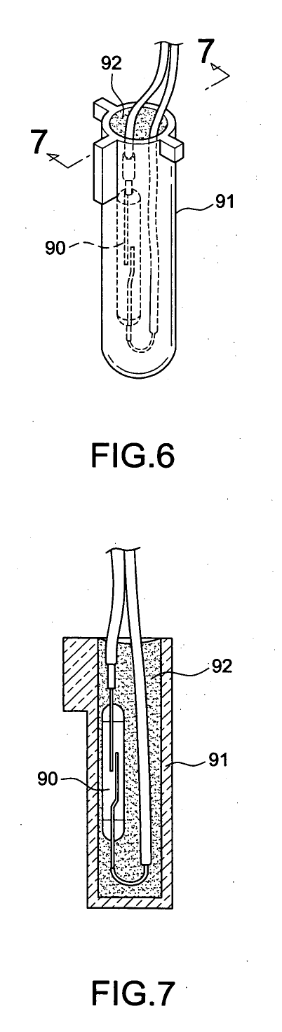

As shown in FIGS. 6 and 7, the magnetic reed pipe is uprightly disposed within a transparent protection sleeve 91 that is filled with a transparent fixing glue 92 for protecting and fixing the magnetic reed pipe. The magnetic reed pipe is visible to check if it is damaged since the protection sleeve 91 and the fixing glue 92 are transparent. The axial direction of the magnetic reed pipe is preferably the same to the radial direction of the transmission gear 42. If the axial direction of the magnetic reed pipe is perpendicular to the radial direction of the transmission gear 42, the magnetic reed pipe can produce a measuring signal once or twice (two reeds within the magnetic reed pipe can be activated) when the magnet 421 disposed at the transmission gear 42 passes through the installation position of the magnetic reed pipe due to the rotation of the transmission gear 42. In this way, an instable measurement may happen.

Based on the above-mentioned configuration, the sensing element 90 of the invention is used to measure the number of the rotation of the transmission gear 42. In this embodiment, the sensing element 90 is a magnetic reed pipe. At least one magnet 421 is disposed at the transmission gear 42. As a result, the magnetic reed pipe will produce a measuring signal once when the magnet 421 disposed at the transmission gear 42 passes through the installation position of the magnetic reed pipe due to the rotation of the transmission gear 42. In this way, the number of the rotation of the transmission gear 42 can be determined. In other words, the change of the transmission travel of the transmission rod 70 can be mastered. As a result, the transmission state of the transmission rod 70 may be simultaneously controlled during the measurement of the signals. In applying to the treadmill, the inclination of the treadmill can be adjusted. Consequently, the transmission mechanism capable of simultaneously measuring and controlling the transmission travel can achieve an accurate control of the transmission travel.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A transmission mechanism capable of simultaneously measuring and controlling the transmission travel, comprising:
a) a transmission unit having a reduction gearset and a transmission gear both of which are disposed within a housing, at least a magnet being disposed at the transmission gear;
b) a motor installed at the external side of the housing for supplying power to the transmission unit;
c) a transmission rod passing through the housing so as to engage with the transmission gear;
d) a fixing sleeve disposed at the external side of the housing und mounted at one end of the transmission rod; and
e) a sensing element opposing to the transmission gear and disposed within the housing for measuring the number of the rotation of the transmission gear, the sensing element including a magnetic reed pipe uprightly disposed within a transparent protection sleeve that is filled with a transparent fixing glue, wherein the axial direction of the magnetic reed pipe is preferably the same to the radial direction of the transmission gear such that a reliable measurement of the number of rotation of the transmission gear is ensured.

2. The transmission mechanism capable of simultaneously measuring and controlling the transmission travel in claim 1 wherein the transmission rod is a threaded rod.
